(19) United States
(12) Patent Application Publication
(10) Pub. No.: US 2004/0256778 A1
(43) Pub. Date: Dec. 23, 2004

(54) ATV coil spring preload equalizing adjuster

(76) Inventor: Frank Verriet, Mississauga (CA)

Correspondence Address: CARLSON, GASKEY & OLDS, P.C., 400 WEST MAPLE ROAD, SUITE 350, BIRMINGHAM, MI, 48009, US

(21) Appl. No.: 10/463,162

(22) Filed: Jun. 17, 2003

(51) Int. Cl. F16F 7/00

(52) U.S. Cl. 267/218; 267/64.28

(57) ABSTRACT

A suspension system includes at least one shock absorber and corresponding preload cylinder. An adjuster mechanism is within reach of a vehicle operator for easily changing the suspension stiffness. Changes to the position of the adjuster mechanism will correspondingly adjust the position of the preload cylinder. A display is connected to the adjuster mechanism so that a vehicle operator may adjust the system to the desired setting. The display corresponds to the payload weight on the vehicle. The vehicle operator may change the position of the adjuster mechanism until the desired setting is shown on the display. The system may be used on either front or rear shock absorbers.

### BACKGROUND OF THE INVENTION

The present invention relates to an adjuster mechanism and more particularly to an adjuster mechanism for use in adjusting a spring preload for an off road vehicle (ORV) or all terrain vehicle (ATV).

Suspension systems in vehicles are commonly subjected to varying road conditions. This is especially true in ORV's, ATV's, snowmobiles, and the like. These vehicles may have adjustable suspension systems to accommodate the preferences of the vehicle operator on irregular terrain. Known systems that allow for one remote adjuster for all shock absorbers have been directed toward adjustment of the internal pressure of the shock absorber, as opposed to an external preload cylinder.

Preload cylinders have been connected to, and are typically concentric with, shock absorbers for adjusting the spring rate of the shock absorber. The preload cylinder may support the spring associated with the shock absorber. Adjustment of the preload cylinder varies the load placed on the suspension springs thus increasing or decreasing the suspension stiffness. The desired comfort level of suspension stiffness varies from operator to operator. For example, the weight of the operator affects the performance of the suspension system making the suspension stiffness vary. The affect of varying weight is especially noticeable on the performance of suspension systems in smaller vehicles like snowmobiles and ATVs.

Many systems have developed the ability to allow for adjustment of the suspension while the vehicle is in operation by providing an adjustment mechanism within reach of the operator. Prior art adjustment systems present the problem of being subjective. Adjustment mechanisms have been provided that include an adjustment knob with settings given in generic terms, which may have different meanings to each operator. The settings for example may be “firm,” “medium,” and “soft.” Moreover, the subjective terms may not be correlated to the payload on the shock absorber. As a result several iterations may still be required to achieve the desired comfort level.

Accordingly, it is desirable to provide a suspension adjustment system which allows for equal preload adjustment and which provides an objective standard for measuring the adjustment.

### SUMMARY OF THE INVENTION

The suspension system according to the present invention provides an objective load display for making adjustments to a preload cylinder.

The suspension system includes at least one shock absorber and corresponding preload cylinder. The preload cylinder is adjustable by a lever attached to an adjuster mechanism. The adjuster mechanism is within reach of a vehicle operator for easily changing the suspension stiffness while the vehicle is in operation. Changes to the position of the adjuster mechanism will correspondingly adjust the position of the preload cylinder and thus vary the spring stiffness of a spring associated with the shock absorber.

A display is associated with the adjuster mechanism so that a vehicle operator may adjust the system to the desired setting. For example, the display may correspond to the payload weight on the vehicle indicated in increments of weight. The vehicle operator may change the position of the adjuster mechanism until the desired setting is shown on the display. The system will adjust the stiffness of the preload cylinder to correspond to the new position.

There may be more than one preload cylinder connected to an adjuster mechanism. Changes in the adjuster mechanism will affect all preload cylinders equally. Thus, only one adjuster mechanism is needed. The system may be used on front and/or rear shock absorbers.

The present invention therefore is an objective method for adjusting a preload cylinder position.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of the suspension system of the present invention;

FIG. 2 is a partial cross-sectional view of the shock absorber and preload cylinder of the present invention; and

FIG. 3 is a side view of an adjuster mechanism of the present invention.

### DETAILED DESCRIPTION OF THE PREFERRED EMBODIMENT

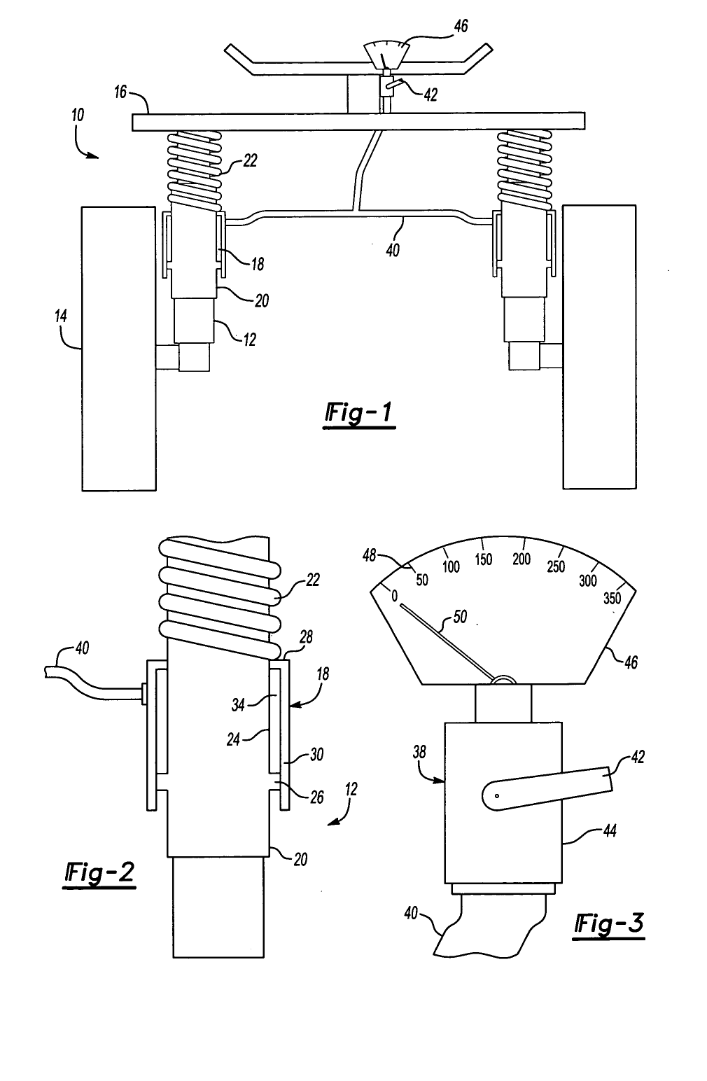

FIG. 1 illustrates a suspension system 10 in an ATV. The suspension system includes a shock absorber 12 mounted between a wheel 14 and a vehicle body 16. The shock absorber 12 has a preload cylinder 18. The preload cylinder 18 is mounted between a shock absorber housing 20 and a coil spring 22.

The preload cylinder 18, shown in FIG. 2, is arranged about the shock absorber housing 20. An outer wall 30 of the preload cylinder is spaced apart from the shock absorber housing 20 to form an internal chamber 34. The lower wall 26 of the internal chamber is formed by a shoulder extending from the shock absorber housing 20. The outer wall 30 extends down, past the lower wall 26. This allows the size of the preload cylinder 18 to be adjusted without creating a leak of the fluid and loss in pressure to the internal chamber 34.The upper surface 28 of the preload cylinder 18 supports the coil spring 22.

An adjuster mechanism 38 is displayed in FIG. 3. The adjuster mechanism 38 is located remotely from the preload cylinder 18. It is preferably mounted on the handlebars or in a position within easy reach of the vehicle operator. The adjuster mechanism 38 is moveable between a plurality of positions which correspond to positions of the preload cylinder 18. A plurality of spring rates correspond with the preload cylinder 18 position. The adjuster mechanism 38 is connected to the preload cylinder by a fluid line 40. By adjusting the lever 42 this will change the position of the adjuster mechanism 38 resulting in an increase or decrease the amount of fluid that is in the preload cylinder 18. A pressurized fluid reservoir and valving may be used, as is well known in the art, to communicate fluid to the preload cylinder.

For example, as fluid is added to the preload cylinder 18 the internal pressure inside the cylinder 18 increases. The increase in pressure creates a force on the walls of the preload cylinder 18. The force placed on the preload cylinder 18 by the coil spring 22 is now greater than the force created by the internal fluid pressure. To equalize the pressure, the upper surface 28 of the preload cylinder 18 will move up increasing the area within the preload cylinder 18. The upward motion of the upper surface 28 will cause a corresponding compression of the coil spring 22. The compression in the coil spring changes the spring rate.

Likewise a decrease in fluid will cause an unequal balance in pressure. The coil spring 22 will exert more force then the fluid inside the preload cylinder 18. The cylinder 18 will correspondingly move downward to equalize the pressure permitting the spring to extend.

The adjuster mechanism includes a lever 42 and a housing 44. The fluid level within the preload cylinder 18 may be adjusted by using the lever 42. A vehicle payload weight setting 46 is attached to the adjuster mechanism 38. Thus, the vehicle payload weight setting 46 reflects the desired position of the preload cylinder 18. The lever 42 can be adjusted until the vehicle payload weight setting 46 reflects the correct position. The adjuster mechanism 38 will then make the corresponding adjustments to the system to reflect this change.

The vehicle payload weight setting 46 includes scale 48 to designate the load on the suspension system. For example, these may be given in units of weight. Thus, a system operator may adjust the setting to reflect the payload that will be placed on the suspension system. As the system is adjusted, the indicator 50 will reflect the new payload setting. The payload setting may be the passenger's weight, for example. The adjuster mechanism 38 then makes the appropriate adjustments to reflect the change. The embodiment shown utilizes a lever and scale display. However, it should be known that an electronic control and display may be used as well.

The adjuster mechanism 38 may be attached to one shock absorber or, as shown, two shock absorbers 12. Alternatively, the system may be used with all of the shock absorbers on the vehicle.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A suspension system comprising:
a shock absorber having a preload cylinder adjustable to provide a plurality of spring rates;
an adjuster mechanism connected to said preload cylinder, wherein said adjuster mechanism is user-operable to select between said plurality of spring rates; and
a desired vehicle payload weight setting corresponding to said plurality of spring rates, said desired vehicle payload weight setting being user-selectable by said adjuster mechanism to adjust said preload cylinder based upon a load on said shock absorber.

2. The suspension system as recited in claim 1, wherein said desired vehicle payload weight setting corresponds to a weight of a passenger.

3. The suspension system as recited in claim 1, wherein said desired vehicle payload weight setting is displayed in increments based on units of weight.

4. The suspension system as recited in claim 1, wherein said adjuster mechanism includes a lever, said lever is manually adjustable, and adjustment of said lever adjusts a position of an indicator on a scale reflecting said desired vehicle payload weight setting.

5. The suspension system as recited in claim 1, wherein said adjuster mechanism includes an electronic control device having a digital display for displaying said desired vehicle payload weight setting and electronic controls for selecting between said plurality of spring rates.

6. The suspension system as recited in claim 1, wherein said adjuster mechanism is remote from said preload cylinder.

7. The suspension system as recited in claim 1, wherein a spring is supported adjacent said preload cylinder, said spring having said plurality of spring rates as provided by said preload cylinder.

8. The suspension system of claim 7, wherein said desired vehicle payload weight setting corresponds to a weight of a passenger.

9. A suspension system comprising:
a first shock absorber having a first preload cylinder adjustable to provide a first plurality of spring rates;
a second shock absorber having a second preload cylinder adjustable to provide a second plurality of spring rates; and
an adjuster mechanism having a plurality of user-selectable settings corresponding to said first and said second pluralities of spring rates, wherein said first plurality of spring rates are approximately equal to said second plurality of spring rates.

10. The suspension system of claim 9, wherein said first and said second shock absorbers are front shock absorbers.

11. The suspension system of claim 9, wherein said first and said second shock absorbers are rear shock absorbers.

12. The suspension system of claim 9, wherein a first coil spring is supported adjacent said first preload cylinder and a second coil spring is supported adjacent said second preload cylinder.

13. The suspension system of claim 12, wherein said plurality of user-selectable settings of said adjuster mechanism correspond to a payload weight on a vehicle.

14. A method of adjusting a suspension system comprising the steps of:
(a) providing a first shock absorber having a first preload cylinder fluidly connected to an adjuster mechanism;
(b) selecting an adjuster mechanism setting to reflect a desired vehicle payload weight corresponding to a load on the first shock absorber, and
(c) adjusting the first preload cylinder to change a first spring rate of a spring based upon the adjuster mechanism setting.

15. The method as recited in claim 14, wherein said step (c) further comprises varying a fluid pressure inside the first preload cylinder based upon the adjuster mechanism setting.

16. The method as recited in claim 15, wherein said step (c) further comprises adjusting the length of said first preload cylinder based upon a change in fluid pressure.

17. The method as recited in claim 16, wherein said step (c) further comprises extending or compressing the spring based upon a change in preload cylinder length.

18. The method as recited in claim 14, further comprising;
(d) providing a second shock absorber having a second preload cylinder fluidly connected to the adjuster mechanism; and
(e) adjusting the second preload cylinder to change a second spring rate based upon a change in the adjuster mechanism setting.

19. The method as recited in claim 18, wherein said step (e) further comprises adjusting the first preload cylinder and the second preload cylinder approximately equally.
